(19) United States
(12) Patent Application Publication
(10) Pub. No.: US 2008/0038169 A1
(43) Pub. Date: Feb. 14, 2008

(54) METHOD FOR TREATING HEAVY METALS FROM AN EFFLUENT CONTAINING CHELATING AGENTS (EDTA, CDTA, OR CITRATE)

(75) Inventors: Hai-Loc Phan, Longueuil (CA); Charles Tessier, Granby (CA)

Correspondence Address: CANTOR COLBURN LLP - IBM FISHKILL, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/463,439

(22) Filed: Aug. 9, 2006

(51) Int. Cl. C01F 7/04

(52) U.S. Cl. 423/120

(57) ABSTRACT

A method is disclosed for removing heavy metals from a solution of waste or effluent containing chelating agents such as ethylenediamine tetraacetic acid (EDTA), 1,2-cyclohexanediamine tetraacetic acid(CDTA), and citric acid(Citrate), comprising:

acidifying the solution with nitric acid, and

oxidization of the acidified solution under controlled pressure and temperature.

Upon oxidation, the heavy metal chelate (EDTA-m, CDTA-m or Citrate-m) is decomplexed, and heavy metal ions are liberated and can be precipitated using a conventional precipitation method such as by treatment with lime and a flocculent.

### BACKGROUND OF THE INVENTION

1. Field of the Invention

The invention relates to a method for treating liquid containing chelated heavy metals. More specifically, the invention relates to a new method to liberate the heavy metals captured by chelating agents (EDTA-m, CDTA-m or Citrate-m), dissolved in aqueous solution. Heavy metals can then be precipitated by the addition of lime and/or anionic polymer at an optimal pH.

2. Description of the Prior Art

Heavy metals (e.g., nickel, Ni; copper, Cu, or the like) are components that can be found in wastes and waste water effluents from electronic plating lines. However, treatment to remove heavy metals of waste streams in which the metals are complexed with chelating agents, e.g., ethylene diamine tetraacetic acid (“EDTA”), trans-1,2-cyclohexanediamine tetraacetic acid (“CDTA”), or citric acid (“Citrate”), and that form strong complexes of the chelating agent(s) with the heavy metal (e.g., metal-EDTA complex (“EDTA-m”), metal-CDTA complex (“CDTA-m”), or metal-Citrate complex (“Citrate-m”), where m represents the heavy metal), are ineffective. Heavy metals are typically recovered by precipitation of insoluble forms of the heavy metals from a solution of the waste by treatment with hydroxide (“⁻OH”) or sulfide (“S²⁻”), but such recovery treatments can be insufficient to break up the strong complex of the heavy metal and chelating agent, thereby preventing precipitation of the heavy metal.

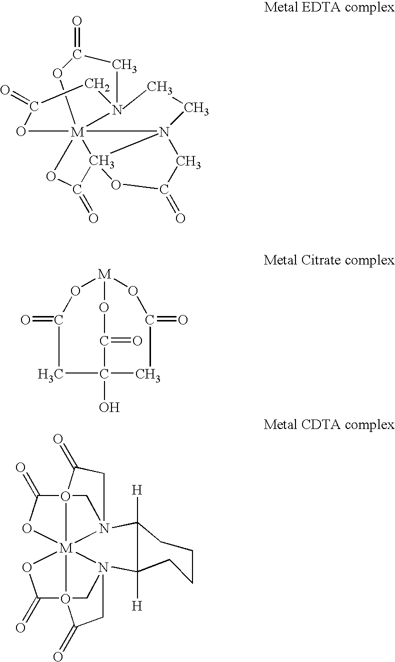

### SUMMARY OF THE INVENTION

In an embodiment, it has been found that the problems associated with removal of heavy metals in waste water in the presence of chelating agents can be overcome by decomplexing the chelated heavy metal complex by acidification and oxidation of the chelating agent and precipitation of the heavy metals from a waste effluent. In the process, the chelated metal is degraded (i.e., destroyed) to free the heavy metal. In the method, the chelating agent/heavy metal complex (also referred to herein as the chelated heavy metal) is degraded by:

acidifying the solution of waste water with nitric acid, and

oxidizing the acidified solution under controlled pressure and temperature.

In carrying out the method of this invention, a waste solution containing heavy metals with chelating agents is acidified with nitric acid(virgin nitric acid, used nitric acid, or a combination of these), and the temperature and pressure are increased to about 200° C. and maintained for about 60 minutes, at a reactor pressure of about 700 psig. The nitric acid is added in an amount of about 1 mole per 0.0034 mole of chelant. After the oxidizing, the heavy metals in the solution are precipitated by raising pH to about 9.6 with lime, followed by an addition of an anionic polymer to help flocculation.

In another embodiment, a continuous method for the treatment of heavy metals from a chelating solution containing one or more of a chelating agent selected from the group consisting of EDTA, CDTA and citrate, comprises adding nitric acid under controlled pressure and temperature to a reactor containing the chelating solution to degrade the chelating agent and provide a solution containing unchelated heavy metals for precipitation, wherein precipitation comprises transferring the solution containing unchelated heavy metals from the reactor to a metal precipitation tank, adding lime and/or anionic polymer to form insoluble heavy metals in an effluent, and transferring the effluent to a clarification system for separation of the insoluble heavy metals from the effluent.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which provides a reduction in the amount of chelated heavy metals in the waste stream of an electronic plating line of at least 78% to as high as greater than 99.9% heavy metal removal, based on the initial concentration (in mg/L) of heavy metal.

### BRIEF DESCRIPTION OF THE DRAWINGS

FIG. 1 illustrates an example of a process flow for acid treatment of a solution containing chelated heavy metals from a waste effluent.

FIG. 2 illustrates another example of a process flow for a complete treatment for removal of heavy metals from a waste effluent.

The detailed description explains the preferred embodiments of the invention, together with advantages and features, by way of example with reference to the drawings.

### DETAILED DESCRIPTION OF THE INVENTION

The shortcomings of the prior art are overcome and additional advantages are provided through the provision of a method for treating heavy metals (e.g., nickel, Ni; copper, Cu, lead, Pb; silver, Ag; gold, Au; platinum, Pt; palladium, Pd; tin, Sn; molybdenum, Mo; tungsten, W; iron, Fe; zinc; Zn, manganese, Mn; aluminum, Al; or the like) in a chelating solution of waste effluent from an electronic plating line. Methods that can accomplish this desirably involve degradation (i.e., destruction) of the chelating agent of the chelated heavy metal complex. Upon breaking up of the complex, the heavy metals complexed with chelating agents(EDTA-m, CDTA-m or Citrate-m) can be liberated, and the liberated heavy metals can then be precipitated by a precipitation method. The method provides for substantial reduction of up to 99.9% of the amount of heavy metal present, based on the concentration of heavy metal in the form of its chelate (e.g., EDTA-m, CDTA-m, or Citrate-m).

The method includes acidification and oxidation of the solution of the chelated heavy metals to decomplex the chelating agent. The heavy metals can then be precipitated by conversion to insoluble species. The decomplexation of the heavy metal chelate is desirably effected using an oxidizing acid(e.g., nitric acid) at a concentration of greater than or equal to 1 mole of acid per 0.0034 mole of heavy metal chelate. Elevated temperature (up to about 200° C.) increases the decomplexation efficiency of the treatment and allows a higher recovery of heavy metal for the process. Effectively and economically done, this treatment oxidizes the chelating agents and releases heavy metals for conventional precipitation processes.

The chelating solution contains, in addition to heavy metals, one or more chelating agents (i.e., chelators) selected from the group consisting of EDTA, CDTA and citrate. Chelating agents, when forming a heavy metal complex, co-ordinate to the metal through their constituent chelating groups. In the cases of EDTA, CDTA, or Citrate, the chelating groups include carboxylate groups or both carboxylate and amine groups. Complexation is in part thermodynamically driven by the stability of the complex formed, i.e., the energy released by formation of a low energy complex of the chelating agent and the metal. Complexation is also entropically driven by the increase in the ambient concentration of mobile ions (such as protons) liberated from the chelating agent, and solvent liberated from the solvated heavy metal ions, upon complexation with the chelating agent. In the chelated form, such heavy metals so complexed are highly stable and water soluble, and are therefore resistant to precipitation by treatment with a precipitating agent such as hydroxide, sulfide, or a anionic polymer flocculent, none of which can compete favorably with the chelating agent in binding to the heavy metals. It is believed that upon treatment of the chelated heavy metal complex with the acid, the chelating groups of the complexed chelating agent are protonated, making binding less favored in the equilibrium. In addition, oxidation by the presence of an oxidizer degrades (i.e., destroys) at least a portion of the chelating agent, further driving the decomplexation to completion. The net effect is to reverse the binding equilibrium and decomplex the heavy metals, making it possible to precipitate the heavy metals using a suitable precipitation procedure. Use of elevated temperatures (e.g., about 200° C.) and a suitable hold time (e.g., about 60 minutes) further increase the oxidizing action of the treatment toward the chelating agent, and thereby enhance the decomplexation of the chelated heavy metals. The treatment can be carried out in a sealed pressure reactor to further enhance the oxidation by the high pressures (e.g., about 700 psig) achieved by heating the treated solution in the reactor.

Acidification of the waste stream to decomplex the chelated heavy metal may be performed using a mineral acid. Exemplary mineral acids include, for example, hydrochloric acid, sulfuric acid, nitric acid, perchloric acid, and the like, or a combination comprising at least one of the foregoing. Further, at least one acid used is an oxidizing acid. In an exemplary embodiment, a useful oxidizing acid for acidification of the waste stream is nitric acid (HNO₃). Suitable nitric acids include virgin nitric acid, used nitric acid, or a combination comprising at least one of the foregoing nitric acids. The oxidizing acid is added to the solution of chelated heavy metal in a concentration sufficient to decompose (i.e., destroy) the chelated heavy metal complex by decomplexing and/or degrading the chelating agent and thereby liberating heavy metal ion(s). Nitric acid is added in a ratio of greater than or equal to about 1 mole per 0.0034 mole of chelating agent. In an exemplary embodiment, about one mole of acid per 0.0034 mole of chelating agent is used.

Treatment of heavy metals from a chelating solution thus includes addition of nitric acid to a reactor containing the chelating solution, followed by heating under controlled pressure and temperature to destroy chelating agents by oxidizing the chelating agent and/or chelated heavy metal complex, to provide unchelated heavy metals for precipitation using a precipitation processes. The precipitation processes can include transferring the solution of unchelated heavy metals from the reactor to a metal precipitation tank and treating the solution of unchelated heavy metals with lime and/or anionic polymer by addition of these to form insoluble heavy metals in an effluent. The effluent is transferred to a clarification system (such as, for example, a decanter) for separation of the effluent from the insoluble heavy metals, which can be recovered as a sludge. The method may be practiced in batch or continuous mode.

In an embodiment, a method for treating a waste solution containing heavy metals complexed with chelating agent and nitric acid is as follows. In an exemplary treatment process, a solution of waste effluent containing the chelated heavy metal is pumped into a reactor for treatment. Nitric acid is added in a ratio of about 1 mole of acid per 0.0034 mole of chelating agent (also referred to herein as “chelant”) to the reactor, and the solution is well mixed using a conventional mixing method compatible with the type of reactor used such as, for example, stirring the solution using an agitator, recirculating, or where a smaller reactor is used, shaking or rolling. The solution in the reactor is heated to a temperature suitable to effect decomplexation of the chelated heavy metals. In an embodiment, the temperature in the reactor is greater than or equal to about 140° C., specifically greater than or equal to about 150° C., and more specifically greater than or equal to about 160° C. In an exemplary embodiment, the temperature in the reactor is about 200° C. Temperature is maintained for a time suitable to effect the decomplexation. In an embodiment, the time at temperature is greater than or equal to about 30 minutes. In an exemplary embodiment, the time at temperature is about 60 minutes. During heating, the pressure in the reactor is observed to increase, and can reach pressures of about 160 to about 700 psig in the reactor. In an exemplary embodiment, the pressure in the reactor is about 700 psig. After holding at temperature, the solution is cooled.

After cooling, the treated solution is transferred to a treatment tank. In an exemplary embodiment, the treated solution is drained from a reactor into an organic equalization tank used in a waste treatment plant by opening the valve of the reactor and draining the treated solution into the organic equalization tank. The acid-treated solution can then be treated conventionally to precipitate the heavy metals using a treatment such as, for example, caustic (i.e., hydroxide), sulfide, or lime (CaCO₃). In an exemplary embodiment, lime is used. A precipitation aid, such as a anionic polymer to help flocculation, may also be used. In an exemplary embodiment, a useful polyacrylamide based anionic polymer is Nalco 1C34, available from Nalco Chemical Canada. Desirably, precipitating the heavy metals is done while maintaining a pH of about 9.6. The heavy metal-containing by product, also referred to herein as “sludge”, may be recovered for disposal or for additional treatment to recover the metals in the sludge. The method may be tested for efficiency by using any suitable standard protocol or method for testing the presence of metals in an effluent after treatment, such as by using flame atomic absorbance (“Flame AA”) spectroscopy, graphite-furnace atomic absorbance (“GFAA”) spectroscopy, inductively-coupled plasma (“ICP”) optical emissions spectrometry (“ICP-OES”) or mass spectrometry (“ICP-MS”), or other suitable methods.

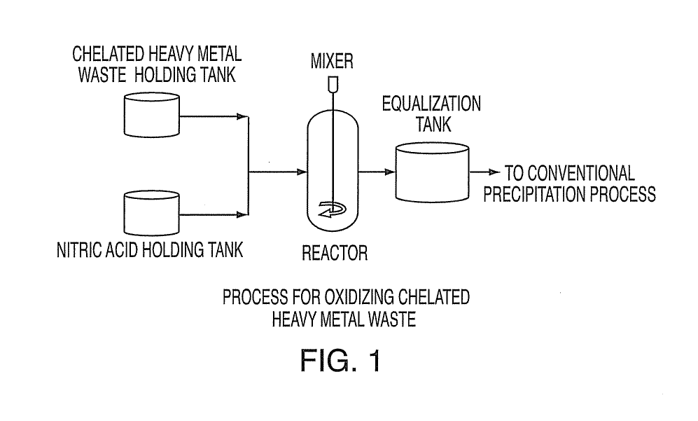

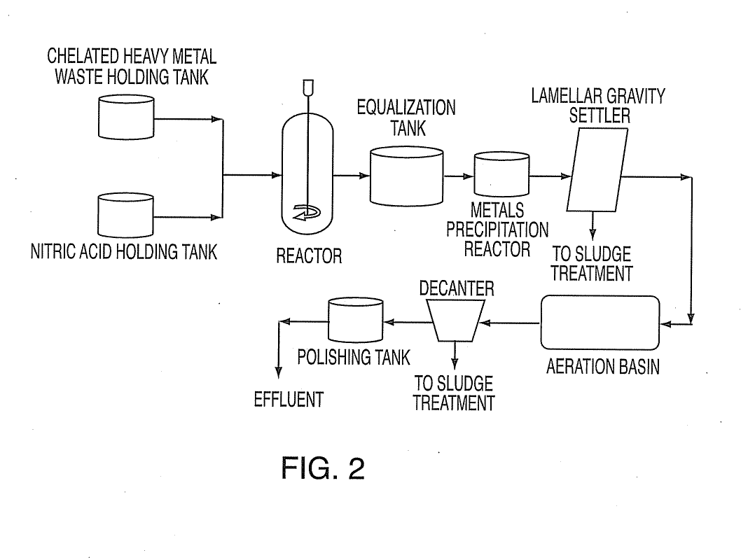

FIGS. 1 and 2 each show exemplary embodiments of the method. In FIG. 1, an example of a process flow for acid and oxidizing treatment of a chelated heavy metal-containing waste is provided. In the process, the chelated heavy metal waste, typically in the form of a solution, is held in a holding tank, while the nitric acid solution is held in a separate holding tank. The waste solution and nitric acid are combined in a reactor, in which the waste solution is added to the holding tank, followed by the desired amount of nitric acid from the nitric acid holding tank. The resulting acidified waste solution is thoroughly mixed by agitation. After mixing, and while still under agitation, the acidified waste solution is heated to about 200° C. Once at temperature, the acidified waste solution is maintained at about 200° C. for about 60 min. During heating and while under temperature hold, the pressure in the reactor can reach a pressure of up to 700 psig. After thermal treatment, the solution is cooled in the reactor to ambient temperature, and transferred to an equalization tank. Conventional processing to precipitate the heavy metals from the acid-treated solution is then performed, such as for example, addition of lime and/or flocculating polymer to precipitate the heavy metals is added to the solution to neutralize the acid. The method may be run in batch mode or continuous mode wherein the flow of treated solution is provided in a continuous stream after precipitation.

In FIG. 2, in an exemplary embodiment, a complete waste treatment process flow is provided. In the process, the chelated heavy metal waste, typically in the form of a solution but not limited thereto, is held in a holding tank, while the nitric acid solution is held in a separate holding tank. The waste solution and nitric acid are combined in a reactor and treated as described hereinabove (e.g., the waste solution is added to the holding tank, followed by the desired amount of nitric acid, and the resulting solution is heated to about 200° C. after mixing and held for about 60 min. under a pressure of about 700 psig). After high temperature and pressure treatment, the solution is cooled to ambient temperature and transferred to an equalization tank. Lime is added to the solution to neutralize the acid and maintain a suitable pH (e.g., about 9.6). The solution may then be transferred to a metals precipitation tank, and further treated conventionally to precipitate the metal (e.g., addition of polymer and/or treatment with hydroxide or sulfide). The solution is transferred to a clarification system such as a lamellar gravity settler or other such apparatus to separate the treated effluent from sludge containing the precipitated heavy metals. The sludge is collected and disposed of, or the metals can be further recovered. The treated effluent may then be aerated to further precipitate additional heavy metals that may remain suspended in the treated effluent. The heavy metal containing sludge from this aeration treatment is allowed to settle in a decanter, and the sludge is collected and disposed of or recovered. The treated effluent is further sent through a polishing tank to remove any additional recoverable heavy metal precipitate, and the treated effluent is finally released to the environment or further purified as desired.

The present invention is further described in the following examples, which are intended to be illustrative and should not be considered as limiting thereto.

The presence of metals in the waste water was determined according to the following method: A 50 ml sample of the effluent was digested with aqua regia in a microwave oven (Mars-X from CEM Corp.) and analyzed by ICP-OES (Optima® 3300DV from Perkin-Elmer). Calibration for metals(e.g., Ni) was performed using metal standards traceable to NIST.

General Procedure for Treatment. A waste solution containing heavy metals complexed with chelating agent and nitric acid is pumped in a ratio of greater than or equal to 1 mole of acid per 0.0034 mole of chelant into the reactor of the bath treatment process, and the temperature of the solution is raised to 200° C. The solution is well mixed prior to heating. After heating to 200° C. for 60 minutes, the pressure is observed to increase, and reaches 700 psig in the reactor. After 60 minutes residence time, the valve at the end of the reactor is opened to drain the liquid to the organic equalization tank of the waste treatment plant. From there, the heavy metal waste can be treated conventionally by precipitating the heavy metals with lime and anionic polymer (i.e., a precipitation aid) while maintaining a pH of about 9.6.

### EXAMPLE 1

The above-described test was conducted using chelated nickel (chelated with EDTA) and varying the parameters of acid concentration, bath temperature, hold (i.e., residence) time, and pressure in different combinations to determine optimal condition to break down the chelated heavy metal complexes. The results are shown in Table 1, below.

TABLE 1

| | Moles of | | | | | | |
|---|---|---|---|---|---|---|---|
| | nitric | | | | | | |
| | acid per | | | | | | |
| | 8.212 × 10⁻⁴ | | | Retention | Ni initial | Ni after | |
| | mole of | Temp. | Pressure | time | conc. | treatment | Reduction |
| Description | chelant | (° C.) | (psig) | (min) | (mg/L) | (mg/L) | (%) |
| Chelating | 0.08 | 200 | 575 | 60 | 31 | 10.90 | 64.93 |
| heavy | 0.16 | 200 | 660 | 60 | 31 | 0.52 | 98.32 |
| metals | 0.24 | 200 | 660 | 60 | 31 | 0.09 | 99.70 |
| complex | 0.32 | 200 | 700 | 60 | 31 | <0.03 | >99.9 |
| wastes | 0.32 | 200 | 700 | 60 | 31 | <0.03 | >99.9 |
| | 0.32 | 180 | 575 | 60 | 31 | 0.33 | 98.9 |
| | 0.32 | 160 | 400 | 60 | 31 | 2.60 | 91.6 |
| | 0.32 | 140 | 160 | 60 | 31 | 3.39 | 89.0 |
| | 0.32 | 200 | 700 | 60 | 31 | <0.03 | >99.9 |
| | 0.32 | 200 | 700 | 50 | 31 | 0.12 | 99.6 |
| | 0.32 | 200 | 700 | 40 | 31 | 0.20 | 99.4 |
| | 0.32 | 200 | 700 | 30 | 31 | 0.28 | 99.1 |

It can be seen in the above table that significant removal of heavy metal (e.g., nickel) of appx. 65% can be achieved using the above method even at low concentrations of nitric acid (0.08 mole per 8.212×10⁻⁴ mole of chelated Ni). The greatest removal of Ni is achieved at a nitric acid concentration of 0.32 mole per 8.212×10⁻⁴ mole of chelated Ni, at a bath temperature of greater than or equal to 180° C. Pressures for the process are dependent primarily upon the temperature of the bath, and to a lesser extent, on the amount of acid present, where an increase in either or both provides a corresponding increase in the pressure obtained in the system. In addition, the amount of time at temperature for the acidification process has a small effect on the percent removal when varied from 30 to 60 minutes at constant temperature and amount of acid per 8.212×10⁻⁴ mole of chelated Ni (200° C. and 0.32 mole HNO₃, respectively), where the longer time for the acidification process provides marginally better Ni removal (less than 1% improvement). The overall greatest removal of Ni is achieved with an acid concentration of 0.32 mol per 8.212×10⁻⁴ mole of chelated Ni, a temperature of 200° C., and a time of 60 minutes, which provides a total removal of Ni of greater than 99.9%, based on the starting molar concentration of Ni.

### EXAMPLE 2

A sample of the same waste solution containing heavy metals complexed with a chelating agent as used in Example 1 was treated with nitric acid, about 1 mole per 0.0034 mole of chelant in a Parr digestion bomb reactor. The bomb reactor was heated in an oven at 200° C. for 60 minutes, during which time the pressure reached 700 psig in the reactor. After cooling the bomb reactor, lime was added to the reaction to increase pH to 9.6, followed by addition of a anionic polymer (Nalco 1C34, available from Nalco Chemical Canada) to accelerate the flocculation. Samples were decanted from the treated solution after 10 minutes and filtered before metals analysis. The results are shown in Table 2.

TABLE 2

| | Initial | After treating by | |
|---|---|---|---|
| | concentration | oven digestion (Parr | Percentage of |
| Heavy metals | (mg/L) | bomb) (mg/L) | removal (%) |
| Aluminum | 2.03 | <0.03 | >98.52 |
| Copper | 0.68 | <0.03 | >95.58 |
| Tin | 0.14 | <0.03 | >78.57 |
| Iron | 3.53 | 0.05 | 98.58 |
| Manganese | 0.08 | 0.01 | 87.50 |
| Molybdenum | 2.86 | 0.48 | 83.21 |
| Nickel | 30.2 | 0.09 | 99.70 |
| Lead | 1.46 | <0.03 | >97.94 |
| Zinc | 0.41 | <0.03 | >92.68 |

Treating of the heavy metals complexed with chelating agents by acidified solution under controlled pressure and temperature is seen in the above Table 2 using one mole acid for 0.0034 mole of the chelated heavy metals. The lowest removal as a percentage of the initial molar amount of the metals is seen with tin, for which at least 78% is removed after processing, followed by molybdenum at 83%, and manganese at 87%. All other metals are removed in amounts greater than 92% based on the concentration (in mg/L) of the heavy metal initially present.

Results in Table 2 thereby show high percentage removal of heavy metals. The efficiency of the acid treatment/decomplexation of the chelated heavy metal permits precipitation and a high percent recovery of the heavy metals from the solution of chelated heavy metal. After treatment, the effluent streams can be further treated or disposed of in accordance with current environmental regulations.

### COMPARATIVE EXAMPLE 1

A sample of the same waste solution containing heavy metals complexed with a chelating agent as used in Example 1 was treated using a conventional method in which lime was added to increase pH to 9.6, followed by the addition of a anionic polymer (Nalco 1C34, available from Nalco Chemical Canada) to accelerate flocculation of the insoluble heavy metals. The sample was decanted after ten minutes and filtered prior to metals analysis. The results are shown in Table 3.

TABLE 3

| | | After treating by | |
|---|---|---|---|
| | Initial concentration | precipitation and | Percentage of |
| Heavy metals | (mg/L) | separation (mg/L) | removal |
| Aluminum | 2.03 | 1.80 | 41.87 |
| Copper | 0.68 | 0.47 | 30.88 |
| Tin | 0.14 | 0.17 | — |
| Iron | 3.53 | 3.06 | 13.31 |
| Manganese | 0.08 | 0.08 | 0.00 |
| Molybdenum | 2.86 | 2.49 | 12.93 |
| Nickel | 30.2 | 26.7 | 11.58 |
| Lead | 1.46 | 1.23 | 15.75 |
| Zinc | 0.41 | 0.38 | 7.31 |

Results in Table 3 clearly demonstrate the inefficiency of the conventional methods for removing chelated heavy metals (i.e., without decomplexing the chelated heavy metals prior to precipitation) in which the highest removal of any metal tested is for aluminum at approximately 42% removal based on the initial concentration (in mg/L) of aluminum present. This performance therefore shows a significantly lower removal of heavy metals than that observed using the acid treatment of Example 2, in which the lowest amount of metal removed is at least 78% for tin, based on the initial concentration (in mg/L) of tin present before treatment.

Compounds are described herein using standard nomenclature. A dash (“—”) that is not between two letters or symbols is used to indicate a point of attachment for a substituent. For example, —CHO is attached through the carbon of the carbonyl (C═O) group. The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference. The terms “first,” “second,” and the like herein do not denote any order, quantity, or importance, but rather are used to distinguish one element from another.

The figures depicted herein describe examples of the invention. There may be many variations to these figures or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for treating heavy metals in a chelating solution containing at least one chelating agent selected from the group consisting of EDTA, CDTA and citrate, comprising:
acidifying the solution with nitric acid, and
oxidizing the acidified solution under controlled pressure and temperature.

2. The method according to claim 1 wherein nitric acid comprises virgin nitric acid, used nitric acid, or a combination comprising at least one of the foregoing, and the nitric acid is added in an amount of about one mole per 0.0034 molar equivalent of the chelating agent.

3. The method according to claim 1 wherein after acidification with nitric acid, the temperature is maintained at about 200° C. for about 60 minutes.

4. The method according to claim 1, wherein the pressure is about 700 psig.

5. The method according to claim 1 further comprising precipitating the heavy metals as insoluble heavy metal hydroxides, wherein after oxidizing, lime is added to achieve a pH of 9.6.

6. The method according to claim 5 wherein precipitating heavy metals further comprises adding anionic polymer to facilitate flocculation.

7. A method for treating heavy metals in a chelating solution containing at least one chelating agent selected from the group consisting of EDTA, CDTA and citrate, comprising:
acidifying the solution with nitric acid, wherein nitric acid comprises virgin nitric acid, used nitric acid, or a combination comprising at least one of the foregoing, and the nitric acid is added in an amount of about one mole per 0.0034 molar equivalent of the chelating agent,
oxidizing the acidified solution under controlled pressure and temperature, wherein after acidification with nitric acid, the temperature is maintained at about 200° C. for about 60 minutes, and wherein the pressure is about 700 psig, and
precipitating the heavy metals as insoluble heavy metal hydroxides, wherein after oxidizing, lime is added to achieve a pH of 9.6 and an anionic polymer is added.

8. A continuous method for the treatment of heavy metals from a chelating solution containing one or more of a chelating agent selected from the group consisting of EDTA, CDTA and citrate, comprising
adding nitric acid under controlled pressure and temperature to a reactor containing the chelating solution to degrade the chelating agent and provide a solution containing unchelated heavy metals for precipitation,
wherein precipitation comprises
transferring the solution containing unchelated heavy metals from the reactor to a metal precipitation tank,
adding lime and/or anionic polymer to the solution containing unchelated heavy metals to form insoluble heavy metals in an effluent, and
transferring the effluent to a clarification system for separation of the insoluble heavy metals from the effluent.
